(19) United States
(12) Patent Application Publication
(10) Pub. No.: US 2013/0011147 A1
(43) Pub. Date: Jan. 10, 2013

(54) DEGRADATION LEVEL ESTIMATING DEVICE AND IMAGE FORMING APPARATUS

(76) Inventors: Michio KIMURA, Shizuoka (JP); Takaaki IKEGAMI, Shizuoka (JP); Tomoharu ASANO, Shizuoka (JP)

(21) Appl. No.: 13/466,461

(22) Filed: May 8, 2012

(30) Foreign Application Priority Data
Jul. 8, 2011 (JP) 2011-151866

(51) Int. Cl. G03G 15/00

(52) U.S. Cl. 399/26

(57) ABSTRACT

A degradation level estimating device for estimating degradation level of a photoreceptor of an image forming apparatus performing at least a charging process, an optical image writing process, a developing process, and a transferring process in which a toner image on the photoreceptor is transferred onto a receiver while applying a charge to the photoreceptor. The degradation level estimating device includes a charge dependence detector to detect charge quantity dependence of a charge property of the photoreceptor in the charging process on the quantity of the charge applied to the photoreceptor in the last transferring process by subjecting the photoreceptor to the processes plural times without performing the optical image writing process, followed by the charging process, while changing the quantity of the charge and measuring the charge property of the photoreceptor. The degradation level estimating device estimates the degradation level of the photoreceptor based on the charge quantity dependence.

### CROSS-REFERENCE TO RELATED APPLICATIONS

This patent application is based on and claims priority pursuant to 35 U.S.C. §119 to Japanese Patent Application No. 2011-151866 filed on Jul. 8, 2011 in the Japan Patent Office, the entire disclosure of which is hereby incorporated herein by reference.

### FIELD OF THE INVENTION

The present invention relates to a degradation level estimating device to estimate the degradation level of a photoreceptor. In addition, the present invention also relates to an image forming apparatus using the degradation level estimating device.

### BACKGROUND OF THE INVENTION

There is a proposal for an image forming apparatus such that difference between the potential of a photoreceptor charged in an initial charging process and the potential of the photoreceptor charged in the second or later charging process is determined to estimate the degradation level of the photoreceptor. In the initial charging process, the surface of the photoreceptor, which has been allowed to settle for a relatively long time, is charged by a charger such as scorotron, and the potential of the charged photoreceptor is measured. In the second (or later) charging process, the photoreceptor, which is charged in the initial charging process and which is not subjected to an optical image forming process, is subjected again to the charging process, and the potential of the charged photoreceptor is measured. In general, as a photoreceptor degrades, the difference between the potential of the photoreceptor in the initial charging process and that in the second (or later) charging process increases. Therefore, the proposed image forming apparatus uses a technique in that after starting to rotate the photoreceptor, the potentials (V_{I} and V_{II}) of the photoreceptor are measured when the number of revolution of the photoreceptor is one and two, to determine the potential difference |V₁-V_{II}|. When the potential difference |V_{I}-V_{II}| exceeds a predetermined value, the life of the photoreceptor is considered to be expired, and the information is displayed in the display of the image forming apparatus.

However, while the potential difference |V_{I}-V_{II}| of a photoreceptor gradually increases, the quality of images produced by the photoreceptor deteriorates rapidly. Thus, degradation of quality of images produced by a photoreceptor cannot be well exhibited by the potential difference |V_{I}-V_{II}|.

For these reasons, the inventors recognized that there is a need for a degradation level estimating device which can determine the degradation level of a photoreceptor more precisely.

### BRIEF SUMMARY OF THE INVENTION

As an aspect of the present invention, a degradation level estimating device for estimating degradation level of a photoreceptor is provided. The degradation level estimating device is used for an image forming apparatus performing an image forming process including at least a charging process, an optical image writing process, a developing process, and a transferring process. The image forming apparatus includes the photoreceptor to bear an electrostatic latent image on a surface thereof while rotating, a charger to subject the surface of the photoreceptor to the charging process in which a charge bias is applied to the surface of the photoreceptor to charge the surface of the photoreceptor, an optical image writing device to subject the photoreceptor to the optical image writing process in which the charged surface of the photoreceptor is irradiated with light to form the electrostatic latent image on the surface of the photoreceptor, a developing device to subject the photoreceptor to the developing process in which the electrostatic latent image is developed with a toner while applying a development bias to the photoreceptor to form a toner image on the surface of the photoreceptor, and a transferring device to subject the photoreceptor to the transferring process in which the toner image on the photoreceptor is transferred onto a receiver while applying a charge (transfer bias) to the surface of the photoreceptor.

The degradation level estimating device includes a charge quantity dependence detector to detect charge quantity dependence of a charge property of the photoreceptor on the quantity of the charge applied to the surface of the photoreceptor in the last transferring process. The charge quantity dependence detector detects the charge quantity dependence by a method including rotating the photoreceptor, and then subjecting the photoreceptor to the image forming process at least twice without performing the optical image writing process, followed by the charging process, while changing the quantity of the charge applied to the photoreceptor in the transferring process and measuring the charge property of the charged photoreceptor to detect the charge quantity dependence of the charge property of the photoreceptor charged in the charging process on the quantity of the charge applied to the photoreceptor in the last transferring process.

The degradation level estimating device determines the charge quantity dependence of the photoreceptor based on the charge property measured by changing the charge quantity, and estimates the degradation level of the photoreceptor based on the charge quantity dependence or an arithmetic data obtained by subjecting the charge quantity dependence to an arithmetic processing.

As another aspect of the present invention, an image forming apparatus is provided which includes a photoreceptor to bear an electrostatic latent image on a surface thereof, a charger to subject the surface of the photoreceptor to the charging process, an optical image writing device to subject the photoreceptor to the optical image writing process to form the electrostatic latent image on the surface of the photoreceptor, a developing device to subject the photoreceptor bearing the electrostatic latent image to the developing process while applying a development bias to the photoreceptor to form a toner image on the surface of the photoreceptor, a transferring device to subject the photoreceptor bearing the toner image thereon to the transferring process while applying a charge to the surface of the photoreceptor, and the degradation level estimating device mentioned above to estimate the degradation level of the photoreceptor.

The aforementioned and other aspects, features and advantages will become apparent upon consideration of the following description of the preferred embodiments taken in conjunction with the accompanying drawings.

### BRIEF DESCRIPTION OF THE SEVERAL VIEWS OF THE DRAWINGS

FIG. 1 is a schematic view illustrating a multifunction product as an example of the image forming apparatus of the present invention;

FIG. 2 is an enlarged view illustrating an image forming unit of the multifunction product;

FIG. 3 is a schematic cross-section illustrating a photoreceptor of the multifunction product;

FIG. 4 is a graph showing the relation between the transfer current applied to a photoreceptor and the surface potential of the photoreceptor;

FIG. 5 is a block diagram illustrating part of an electric circuit of the multifunction product; and

FIG. 6 is a flowchart illustrating a degradation level estimation processing of the controller of the multifunction product.

### DETAILED DESCRIPTION OF THE INVENTION

The present inventors discover that as a photoreceptor degrades, a ghost image problem in that a ghost image of an image formed in the last image forming process is formed on a half tone image of the following image is caused, resulting in formation of an uneven density image. The degradation level of a photoreceptor can be determined more clearly based on this image unevenness than the above-mentioned potential difference.

The present inventors discover the reason why such an uneven density image caused by a ghost image is formed. Specifically, the surface of a photoreceptor starting to be rotated to perform a print job is subjected to a first charging process, a first optical image writing process, a first developing process, and a first transferring process. After the transferring process, the photoreceptor is subjected to a second charging process to form a second image. In the transferring process, in which a toner image on the photoreceptor is transferred to a receiver such as a recording material or an intermediate transfer medium, a transfer current flowing through a non-image area of the photoreceptor is greater than a transfer current flowing through an image area bearing a toner image thereon. In this regard, when the photoreceptor is relatively new, the surface potential of the photoreceptor in the second charging process is hardly affected by the transfer current flowing through the photoreceptor in the first transferring process. Namely, the surface potential of the photoreceptor in the second charging process is substantially equal to the predetermined potential independently of the amount of the transfer current flowing through the photoreceptor in the first charging process. However, after the photoreceptor is repeatedly used for a long period of time, the surface potential of the photoreceptor in the second charging process is seriously affected by the transfer current flowing through the photoreceptor in the first transferring process. Namely, the surface potential of an area of the photoreceptor, which is a non-image area in the first transferring process, is greatly different from the surface potential of another area of the photoreceptor, which is an image area in the first transferring process, because the amount of the transfer currents flowing through the non-image area and the image area of the photoreceptor in the first transfer process are greatly different. When a half tone image is formed on the thus unevenly charged photoreceptor, a ghost image is formed in the half tone image, resulting in formation of an uneven half tone toner image on the photoreceptor.

In addition, as described later in detail, the present inventors performed several experiments in which an image forming process is performed on a photoreceptor at least once without performing an optical image writing process (i.e., a charging process, a developing process and a transferring process are performed), followed by a charging process to measure a charge property (such as a surface potential after the charging process) of the photoreceptor, and then a developing process and a transferring process are performed at least once while changing the quantity of charge applied to the photoreceptor in the transferring processes to measure the charge property of the photoreceptor. As a result, the present inventors discover that by checking the influence of the quantity of charge applied to the surface of the photoreceptor in the transferring processes on the charging property of the photoreceptor, the degradation level of the photoreceptor can be determined.

Specifically, as a photoreceptor deteriorates more seriously, a charging property of the photoreceptor is influenced more seriously when changing the quantity of the charge applied to the surface of the photoreceptor in the last transferring process.

One example of the method for checking the charge quantity dependence of a charge property of the photoreceptor is the following. Specifically, a photoreceptor is rotated to be subjected to a charging process (i.e., application of a charge bias), a developing process (i.e., application of a development bias), and a transferring process (i.e., application of a transfer bias) without performing an optical writing process, followed by the charging process to measure the surface potential (V1) of the photoreceptor charged in the last charging process. Next, after changing the transfer bias current, the photoreceptor is subjected to the charging process, the developing process, and the transferring process, followed by the charging process to measure the surface potential (V2) of the photoreceptor charged in the last charging process and to determine a potential difference (V1−V2) or a potential ratio (V2/V1). It is discovered that the potential difference or the potential ratio correlates to the degradation level of the photoreceptor. In this regard, the linear velocity of the photoreceptor may be changed instead of changing the transfer current. This is because even when the transfer current is not changed, the quantity of charge applied to the photoreceptor in the transferring process can be changed by changing the linear velocity of the photoreceptor. In addition, the amount of toner per a unit area of a toner image on the photoreceptor, which is formed by developing the charged photoreceptor, may be measured instead of measuring the surface potential. This is because the surface potential of a photoreceptor correlates with the amount of toner per a unit area of a toner image formed by developing the charged photoreceptor.

The image forming apparatus of the present invention will be described by reference to drawings.

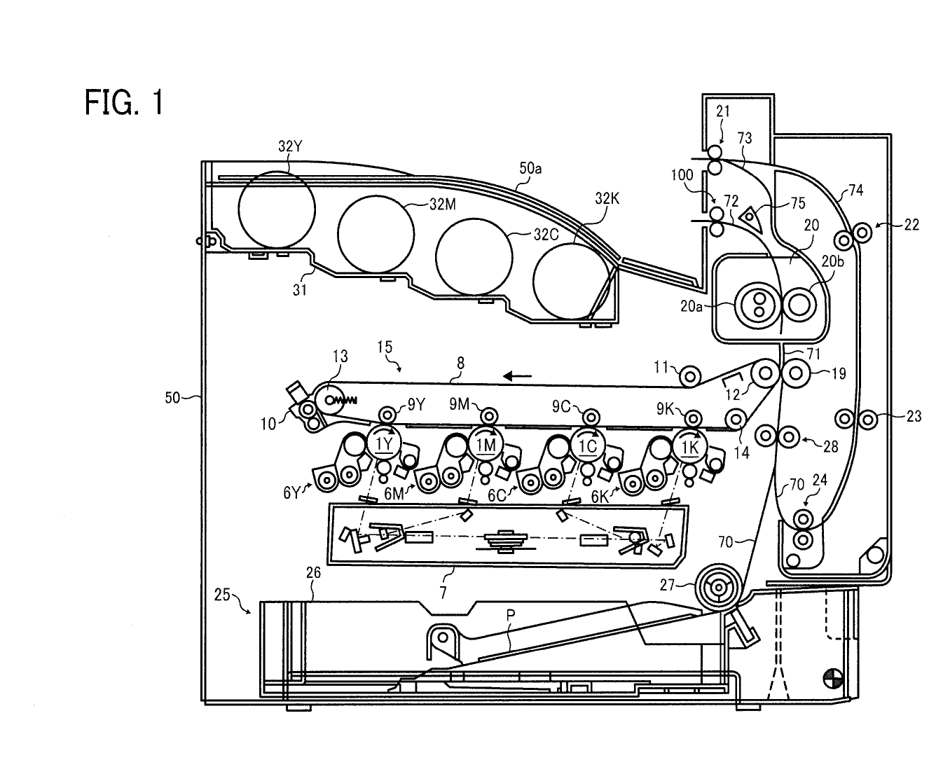

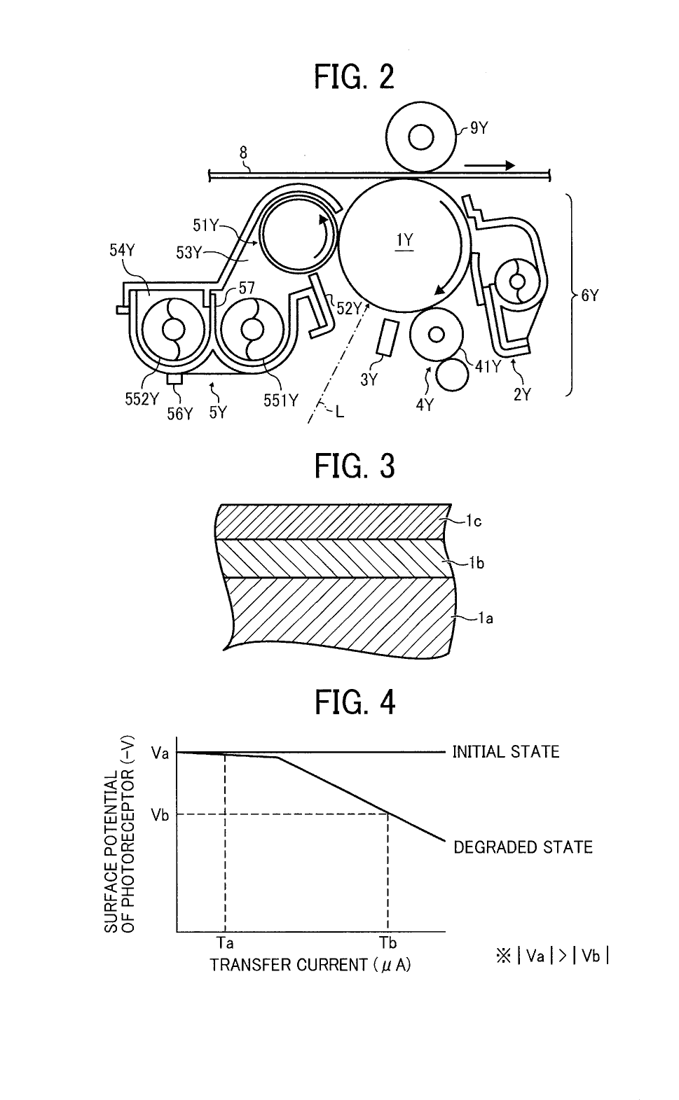

FIG. 1 is a schematic view illustrating a multifunction product as an example of the image forming apparatus of the present invention. This multifunction product includes four image forming units 6Y, 6M, 6C and 6K for forming yellow (Y), magenta (M), cyan (C) and black (K) toner images, respectively. The image forming units 6Y, 6M, 6C and 6K have the same configuration except that the color of the toner used for forming a toner image is different, and each of the image forming units 6 is replaced with a new image forming unit when the life thereof expires. Since the image forming units 6 have the same configuration, the yellow image forming unit 6Y will be hereinafter described as an example by reference to FIG. 2. Referring to FIG. 2, the image forming unit 6Y includes a drum-shaped photoreceptor 1Y, a drum cleaner 2Y to clean a circumferential surface of the photoreceptor 1Y, a surface potential sensor 3Y which serves as a surface potential detector and a pat of the charge quantity dependence detector and which measures the potential of the circumferential surface of the photoreceptor 1Y, a charger 4Y to charge the circumferential surface of the photoreceptor 1Y, and a developing device 5Y to develop an electrostatic latent image formed on the photoreceptor 1Y to form a toner image on the photoreceptor. The image forming unit 6Y is detachably attached to the multifunction product as a single unit.

The charger 4Y includes a charging roller 41Y, which is contacted with the circumferential surface of the photoreceptor 1Y to be rotate thereby and to which a charge bias is applied to cause discharging between the surface of the charging roller 41Y and the surface of the photoreceptor 1Y, thereby evenly charging the surface of the photoreceptor. In this multifunction product, a DC voltage superimposed with an AC voltage is used as the charge bias. By applying an alternate electric field between the charging roller 41Y and the photoreceptor 1Y, bidirectional discharging is caused therebetween, thereby making it possible to evenly charge the surface of the photoreceptor 1Y to have a charge with the same polarity as that of the DC voltage while removing residual charges remaining on the surface of the photoreceptor 1Y. Thus, the charger 4Y also serves as a discharger, and therefore the multifunction product does not have a discharger used only for removing residual charges on the photoreceptor 1Y.

The surface of the photoreceptor 1Y thus charged is then scanned with a laser beam L emitted by an optical image writing device 7 (illustrated in FIG. 1), resulting in formation of an electrostatic latent image for a Y color image on the surface of the photoreceptor 1Y. The electrostatic latent image is developed with a Y developer in the Y developing device 5Y, which includes a Y toner and a magnetic carrier, resulting in formation of a Y toner image on the surface of the photoreceptor 1Y. The Y toner image on the photoreceptor 1Y is primarily transferred to an intermediate transfer belt 8, which serves as a receiver. The drum cleaner 2Y removes residual toner particles remaining on the surface of the photoreceptor 1Y after the primary transfer operation. Similarly, M, C and K toner images are formed on the respective photoreceptors 6M, 6C and 6K, and then transferred onto the intermediate transfer belt 8 so as to be overlaid on the Y toner image, resulting in formation of a combined color toner image on the intermediate transfer belt 8.

The developing device 5Y includes a developing roller 51Y, part of which projects from an opening of a casing of the developing device. The developing roller 51Y includes a cylindrical sleeve, which is made of a non-magnetic and electroconductive material and which is rotatable, and a fixed magnet roller arranged inside the sleeve. The developing device 5Y further includes a first feed screw 551Y and a second feed screw 552Y, a doctor blade 52Y to form an even developer layer on the surface of the developing roller 51Y, and a toner concentration sensor 56Y to detect the toner concentration of the developer in the developing device. The Y developer including a Y toner and a magnetic carrier is contained inside the casing of the developing device 5Y. The Y developer is fed by the first and second feed screws 551Y and 552Y to the sleeve while frictionally charged thereby so as to be born on the surface of the rotating sleeve. The Y developer born on the surface of the rotating sleeve is scraped with the doctor blade 52Y so as to form a developer layer having a predetermined thickness on the surface of the sleeve, and the developer layer is fed to a development region in which the developing roller 51Y is opposed to the photoreceptor 1Y to develop an electrostatic latent image on the photoreceptor. Thus, a Y toner image is formed on the photoreceptor 1Y. The Y developer on the sleeve, which is used for developing the electrostatic latent image and in which part of the Y toner therein is consumed for development, is returned to the casing by rotation of the sleeve.

A partition 57 is provided between the first and second feed screws 551Y and 552Y to separate a first developer feeding portion 53Y, in which the developing roller 51Y and the first feed screw 551Y are arranged, from a second developer feeding portion 54Y, in which the second feed screw 552Y is arranged. The first feed screw 551Y is driven to rotate by a driving device to feed the Y developer in the first developer feeding portion 53Y in a direction of from the front side of the first developer feeding portion 53Y toward the inner side thereof (i.e., from the surface of a paper on which FIG. 2 is illustrated toward the backside of the paper) while feeding the Y developer to the developing roller 51Y. The Y developer fed by the first feed screw 551Y to the inner side of the first developer feeding portion 53Y is fed to the second developer feeding portion 54Y through an opening provided at the inner end of the partition 57. The Y developer is then fed by the second feed screw 552Y from the inner side of the second developer feeding portion 54Y toward the front side thereof The Y developer fed by the second feed screw 552Y to the front end of the second developer feeding portion 54Y is returned to the first developer feeding portion 53Y through another opening provided at the front end of the partition 57.

The toner concentration sensor 56Y, which is a magnetic permeability sensor, is provided on the bottom of the second developer feeding portion 54Y and outputs a voltage corresponding to the magnetic permeability of the Y developer fed above the toner concentration sensor 56Y. Since the magnetic permeability of a two component developer including a toner and a magnetic carrier is well correlated with the toner concentration of the developer, the toner concentration sensor 56Y outputs a voltage corresponding to the toner concentration of the Y developer fed above the toner concentration sensor 56Y. The value of the voltage output by the toner concentration sensor 56Y is informed to a controller of the multifunction product. The controller stores data concerning a target voltage Vtref for each of the Y, M, Cnd K developers. The controller performs control such that a Y toner supplying device is driven to add the Y toner to the second developer feeding portion 54Y, so that the output voltage becomes close to the target voltage Vtref and the toner concentration of the Y developer in the developing device 5Y falls in the predetermined range. The same control is performed in the other developing devices 5.

Referring back to FIG. 1, the optical image writing device 7 is provided below the image forming units 6. The optical image writing device 7 serves as a latent image forming device and irradiates each of the photoreceptors of the image forming units 6 with the laser beams L, which are emitted according to Y, M, C and K image information, while scanning, thereby forming electrostatic latent images corresponding to Y, M, C and K images on the respective photoreceptors 1Y, 1M, 1C and 1K. In the optical image writing device 7, laser beams emitted by a light source are reflected by a polygon mirror rotated by a motor, so that the laser beams irradiate the respective photoreceptors via optical lenses and/or mirrors.

A sheet feeder 25 having a sheet cassette 26 and a feeding roller 27 is provided below the optical image writing device 7. The sheet cassette 26 contains plural sheets of a recording material P, and the uppermost sheet of the recording material is contacted with the feeding roller 27. When the feeding roller 27 is rotated counterclockwise by a driving device, the uppermost recording material sheet P is fed toward a sheet passage 70.

A pair of registration rollers 28 is provided on the sheet passage 70. Although the pair of registration rollers 28 is rotated to nip the recording material sheet P, the pair of registration rollers stops rotation right after nipping the sheet. The pair of registration rollers 28 is timely rotated to feed the recording material sheet P toward a secondary transfer nip mentioned below, so that a toner image on the intermediate transfer belt 8 is transferred onto a proper position of the sheet at the secondary transfer nip.

A transfer unit 15 is provided above the image forming units 6. The transfer unit 15 includes the endless intermediate transfer belt 8, which is rotated counterclockwise while tightly stretched by a roller 11, a drive roller 12, a belt-cleaner backup roller 13, a nip entrance roller 14 and four primary transfer bias rollers 9Y, 9M, 9C and 9K, a secondary bias roller 19, and a belt cleaner 10.

The primary transfer bias rollers 9Y, 9M, 9C and 9K, which serves as a transferring device, are contacted with the respective photoreceptors 1Y, 1M, 1C and 1K with the intermediate transfer belt 8 therebetween to form primary transfer nips. A primary transfer bias having a polarity opposite to that of charge of the toner used is applied to each of the primary transfer bias rollers 9. Other rollers than the primary transfer bias rollers 9 are electrically grounded.

When the intermediate transfer belt 8 is rotated, Y, M, C and K toner images formed on the respective photoreceptors 1Y, 1M, 1C and 1K are primarily transferred onto the intermediate transfer belt 8 at the primary transfer nips so as to be overlaid thereon, resulting in formation of a combined color toner image on the intermediate transfer belt 8.

The drive roller 12 and the secondary transfer bias roller 19 sandwich the intermediate transfer belt 8 to form the secondary transfer nip, and the combined color toner image on the intermediate transfer belt 8 is transferred onto the recording material sheet P at the secondary transfer nip, resulting in formation of a full color toner image.

Residual toner particles remaining on the surface of the intermediate transfer belt 8 even after the intermediate transfer belt passes through the secondary transfer nip are removed by the belt cleaner 10. The recording material sheet P bearing the color toner image thereon is fed to a fixing device 20 via a second sheet passage 71.

The fixing device 20 includes a rotatable fixing roller 20a having a heat source (such as a halogen lamp) therein, and a pressure roller 20b contacted with the fixing roller at a predetermined pressure to be rotated. Since the recording material sheet P bearing the full color toner image thereon is nipped by the fixing roller 20a and the pressure roller 20b such that the toner image is contacted with the fixing roller, the full color toner image is softened by heat and pressure applied by the fixing roller and the pressure roller, resulting in fixation of the full color image on the recording material sheet P.

The recording material sheet P bearing the fixed full color toner image is then fed to a cross point of a discharge path 72 and a pre-reverse passage 73. A swingable switching pick 75 is provided at the cross point to switch the course of the recording material sheet P. Specifically, by moving the front edge of the switching pick 75 in such a direction as to be close to the pre-reverse passage 73, the recording material sheet P is fed along the discharge path 72. In contrast, by moving the front edge of the switching pick 75 in such a direction as to be close to the discharge path 72, the recording material sheet P is fed along the pre-reverse passage 73.

When the recording material sheet P is fed along the discharge path 72, the recording material sheet is discharged from the main body of the multifunction product by a pair of discharging rollers 100 so as to be stacked on a tray 50a formed on the main body of the multifunction product. In contrast, when the recording material sheet P is fed along the pre-reverse passage 73, the recording material sheet enters into a nip of a pair of reverse rollers 21. The pair of reverse rollers 21 feeds the recording material sheet P toward the tray 50a, but is reversely rotated just before a time in which the rear edge of the recording material sheet enters into the nip of the pair of reverse rollers 21, thereby reversely feeding the recording material sheet. Therefore, the recording material sheet P is fed in such as manner that the rear edge of the recording material sheet enters into a reverse passage 74.

The reverse passage 74 extends downward while being curved. A first pair of reverse rollers 22, a second pair of reverse rollers 23, and a third pair of reverse rollers 24 are provided on the reverse passage 74. Since the recording material sheet P is fed through the reverse passage 74 by the first, second and third pairs of reverse rollers, the recording material sheet is reversed. The thus reversed recording material sheet P is fed again through the sheet passage 70 so as to enter into the secondary transfer nip. Another combined toner image formed on the intermediate transfer belt 8 is secondarily transferred onto the opposite side of the recording material sheet P. The recording material sheet P is fed to the fixing device 20 after passing through the second sheet passage 71, so that the toner image is fixed thereon. The recording material sheet P bearing two fixed full color images on both sides thereof (i.e., a duplex full color copy) is fed through the discharge passage 72 so as to be discharged by the pair of discharging rollers 100. Thus, a duplex full color copy is stacked on the tray 50a.

A toner bottle support 31 to support Y, M, C and K toner bottles 32Y, 32M, 32C and 32K respectively containing the Y, M, C and K toners is provided between the tray 50a and the transfer unit 15. The color toners in the toner bottles 32Y, 32M, 32C and 32K are supplied to the respective developing devices 6Y, 6M, 6C and 6K if necessary by respective toner feeders. The toner bottles 32Y, 32M, 32C and 32K are detachably attachable to the multifunction product independently of the image forming units 6Y, 6M, 6C and 6K.

FIG. 3 is an enlarged cross-sectional view illustrating an example of the photoreceptor 1. The photoreceptor includes an electroconductive substrate 1a, a charge generation layer 1b formed on the electroconductive substrate 1a, and a charge transport layer 1c formed on the charge generation layer 1b. The structure of the photoreceptor is not limited thereto, and a protective layer may be formed on the charge transport layer 1c, and/or an undercoat layer may be formed between the electroconductive substrate 1a and the charge generation layer 1b.

Specific examples of the electroconductive substrate 1a include metal cylinders, which are made of a metal such as aluminum, aluminum alloys, nickel and stainless steel and which are subjected to a surface treatment such as cutting, super finishing, polishing and the like treatments. In addition, non-conductive substrates, on the surface of which an electroconductive layer including a binder resin and a particulate electroconductive material dispersed in the binder resin is formed, can also be used as the electroconductive substrate 1a. Specific examples of such a particulate electroconductive material include powders of carbon blacks such as acetylene black; powders of metals such as aluminum, nickel, iron, nichrome, copper, zinc, and silver; and powders of metal oxides such as electroconductive tin oxide, and ITO (indium tin oxide). Specific examples of the binder resins include known thermoplastic resins, thermosetting resins and photo-crosslinking resins, such as polystyrene, styrene-acrylonitrile copolymers, styrene-butadiene copolymers, styrene-maleic anhydride copolymers, polyesters, polyvinyl chloride, vinyl chloride-vinyl acetate copolymers, polyvinyl acetate, polyvinylidene chloride, polyarylate resins, phenoxy resins, polycarbonates, cellulose acetate resins, ethyl cellulose resins, polyvinyl butyral, polyvinyl formal, polyvinyl toluene, poly-N-vinyl carbazole, acrylic resins, silicone resins, epoxy resins, melamine resins, urethane resins, phenolic resins, and alkyd resins.

Such an electroconductive layer can be formed by coating a surface of a non-electroconductive material with a coating liquid in which an electroconductive powder is dispersed in a binder resin dissolved in a proper solvent such as tetrahydrofuran, dichloromethane, methyl ethyl ketone, and toluene, and then drying the coated liquid.

In addition, substrates, in which an electroconductive resin film is formed on a surface of a cylindrical substrate using a heat-shrinkable resin tube which is made of a combination of a resin such as polyvinyl chloride, polypropylene, polyesters, polyvinylidene chloride, polyethylene, chlorinated rubbers, and fluorine-containing resins (such as TEFLON), and an electroconductive material such as electroconductive materials mentioned above, can also be used as the electroconductive substrate 1a.

The charge generation layer (CGL) 1b includes a charge generation material (CGM) as a main component. Suitable materials for use as the charge generation material include monazo pigments, disazo pigments, trisazo pigments, perylene pigments, perynone pigments, quinacridone pigments, quinone-type condensation polycyclic compounds, squaric acid-based pigments, phthalocyanine pigments, naphthalocyanine pigments, and azulenium salt pigments. These materials can be used alone or in combination. The charge generation layer 1b is typically prepared by coating a surface of an electroconductive substrate with a charge generation layer coating liquid, which is prepared by dispersing a charge generation material in a solvent using a mixer (such as ball mills, attritors, sand mills, and supersonic dispersing machines) optionally together with a binder resin, which is dissolved in the solvent, and then drying the coated liquid.

Specific examples of the optional binder resin for use in the charge generation layer coating liquid include polyamide, polyurethane, epoxy resins, polyketone, polycarbonate, silicone resins, acrylic resins, polyvinyl butyral, polyvinyl formal, polyvinyl ketone, polystyrene, polysulfone, poly-N-vinylcarbazole, polyacrylamide, polyvinyl benzal, polyester, phenoxy resins, vinyl chloride-vinyl acetate copolymers, polyvinyl acetate, polyphenylene oxide, polyvinyl pyridine, cellulose resins, casein, polyvinyl alcohol, and polyvinyl pyrrolidone. These resins can be used alone or in combination. The mixing ratio (R/CGM) of a binder resin (R) to a charge generation material (CGM) is generally from 0/100 to 500/100 by weight, and preferably from 10/100 to 300/100 by weight. The method of adding a binder resin is not particularly limited, and a method in which a binder resin is added to a mixture of a CGM and a solvent, and the mixture is subjected to a dispersing treatment to disperse the CGM while dissolving the binder resin, or a method in which a binder resin is dissolved in a CGM dispersion prepared previously.

Specific examples of the solvent for use in preparing a charge generation layer coating liquid include isopropanol, acetone, methyl ethyl ketone, cyclohexanone, tetrahydrofuran, ethylcellosolve, ethyl acetate, methyl acetate, cyclohexane, toluene, xylene, and ligroin. Among these solvents, ketone solvents, ester solvents and ether solvents are preferable. These solvents can be used alone or in combination.

The charge generation layer coating liquid can optionally include additives such as sensitizers, dispersants, surfactants, and silicone oils. Specific examples of the coating methods for use in coating the charge generation layer coating liquid include dip coating, spray coating, bead coating, nozzle coating, and ring coating. The thickness of the charge generation layer is generally from 0.01 μm to 5 μm, and preferably from 0.1 μm to 2 μm.

The charge transport layer (CTL) 1c includes a charge transport material (CTM) as a main component, which is typically dispersed in a binder resin. The added amount of a charge transport material (CTM) in the charge transport layer (CTL) 1c is from 30 to 200 parts by weight based on 100 parts by weight of the binder resin component included in the CTL. When the added amount of a CTM is less than 30 parts by weight based on 100 parts by weight of a binder resin, electrostatic properties of the photoreceptor tend to deteriorate (for example, the residual potential of the photoreceptor tends to increase). In contrast, when the added amount is greater than 200 parts by weight, the mechanical properties of the photoreceptor tend to deteriorate (for example, the abrasion resistance of the photoreceptor tends to increase).

Specific examples of the charge transport materials (CTMs) include any known materials such as poly-N-vinyl carbazole and its derivatives, poly-γ-carbazolylethylglutamate and its derivatives, pyrene-formaldehyde condensation products and their derivatives, polyvinyl pyrene, polyvinyl phenanthrene, polysilane, oxazole derivatives, oxadiazole derivatives, imidazole derivatives, monoarylamine derivatives, diarylamine derivatives, triarylamine derivatives, stilbene derivatives, α-phenyl stilbene derivatives, benzidine derivatives, diarylmethane derivatives, triarylmethane derivatives, 9-styrylanthracene derivatives, pyrazoline derivatives, divinyl benzene derivatives, hydrazone derivatives, indene derivatives, butadiene derivatives, pyrene derivatives, bisstilbene derivatives, and enamine derivatives. These materials can be used alone or in combination.

Specific examples of the binder resins for use in the charge transport layer (CTL) 1c include known thermoplastic resins and thermosetting resins, such as polystyrene, styrene-acrylonitrile copolymers, styrene-butadiene copolymers, styrene-maleic anhydride copolymers, polyester, polyvinyl chloride, vinyl chloride-vinyl acetate copolymers, polyvinyl acetate, polyvinylidene chloride, polyarylate resins, phenoxy resins, polycarbonate, cellulose acetate resins, ethyl cellulose resins, polyvinyl butyral, polyvinyl formal, polyvinyl toluene, poly-N-vinyl carbazole, acrylic resins, silicone resins, epoxy resins, melamine resins, urethane resins, phenolic resins, and alkyd resins. The thickness of the CTL 1c is preferably not greater than 50 μm, and more preferably not greater than 35 μm so that the resultant photoreceptor has a good response and produces high definition images. The lower limit of the thickness is determined depending on the image forming conditions (particularly, the potential of the charged photoreceptor), and is preferably 10 μm.

Suitable solvents for use in the CTL coating liquid (i.e., solvents for use in dissolving or dispersing a charge transport material and a binder resin) include tetrahydrofuran, toluene, cyclohexanone, methyl ethyl ketone, and acetone. These solvents can be used alone or in combination. Specific examples of the coating methods for use in coating the charge transport layer coating liquid include known coating methods such as dip coating, spray coating, bead coating, nozzle coating, and ring coating.

The photoreceptor for use in the image forming apparatus of the present invention can include an undercoat layer between the electroconductive substrate 1a and the charge generation layer (CGL) 1b. The undercoat layer includes a resin as a main component. Since the charge generation layer is typically formed by coating the undercoat layer with a charge generation layer coating liquid including an organic solvent, the resin in the undercoat layer preferably has good resistance to general organic solvents.

Specific examples of such resins include water-soluble resins such as polyvinyl alcohol resins, casein, and polyacrylic acid sodium salts; alcohol soluble resins such as nylon copolymers, and methoxymethylated nylon resins; and thermosetting resins having a three-dimensional network such as polyurethane resins, melamine resins, alkyd-melamine resins, and epoxy resins.

The undercoat layer can include a particulate metal oxide such as titanium oxide, silica, alumina, zirconium oxide, tin oxide, and indium oxide to prevent formation of moire in the resultant images and to decrease the residual potential of the resultant photoreceptor.

The undercoat layer is typically formed by coating the electroconductive substrate with a coating liquid, in which the above-mentioned materials are dissolved or dispersed in a solvent, using a proper coating method.

The undercoat layer may be formed using a silane coupling agent, a titanium coupling agent or a chromium coupling agent. In addition, a layer of aluminum oxide which is formed by an anodic oxidation method, and a layer of an organic compound such as polyparaxylylene or an inorganic compound such as SiO, SnO₂, TiO₂, ITO or CeO₂ which is formed by a vacuum evaporation method, can also be used as the undercoat layer. The thickness of the undercoat layer is preferably 0 to 10 μm.

A protective layer including a resin as a main component is optionally formed on the charge transport layer 1c. Specific examples of such a resin include acrylonitrile-butadiene-styrene (ABS) resins, acrylonitrile-chlorinated ethylene-styrene (ACS) resins, olefin-vinyl monomer copolymers, chlorinated polyether, aryl resins, phenolic resins, polyacetal, polyamide, polyamideimide, polyacrylate, polyarylsulfone, polybutylene, polybutylene terephthalate, polycarbonate, polyether sulfone, polyethylene, polyethylene terephthalate, polyimide, acrylic resins, polymethylpentene, polypropylene, polyphenylene oxide, polysulfone, polystyrene, polyarylate, acrylonitrile-styrene (AS) resins, butadiene-styrene copolymers, polyurethane, polyvinyl chloride, polyvinylidene chloride, and epoxy resins. Among these resins, polycarbonate and polyarylate are preferable because the resins can satisfactorily disperse a filler therein so that coating defects are hardly formed in the resultant protective layer, and the resultant photoreceptor has a low residual potential.

The protective layer can include a filler to improve the abrasion resistance thereof. The protective layer is typically formed by coating the charge transport layer 1c with a protective layer coating liquid including a solvent, a resin dissolved in the solvent, and a filler dispersed in the solvent. Specific examples of the solvent include tetrahydrofuran, toluene, cyclohexanone, methyl ethyl ketone, and acetone. It is preferable for the solvent to be highly volatile and to have a property such that when a filler is dispersed, the dispersion has a relatively high viscosity. If these is no solvent satisfying these properties at the same time, it is preferable to use a combination of two or more solvents. Specific examples of the coating method of forming the protective layer include known coating methods such as dip coating, spray coating, bead coating, nozzle coating, and ring coating. Among these coating methods, spray coating is preferable because a protective layer having uniform surface can be formed.

The photoreceptor for use in the image forming apparatus can optionally have an intermediate layer between the charge transport layer 1c and the protective layer to prevent occurrence of a problem in that the charge transport layer 1c is damaged by a protective layer coating liquid. Such an intermediate layer includes a binder resin as a main component. Specific examples of the binder resin include polyamide, alcohol-soluble nylon, water-soluble polyvinyl butyral, polyvinyl butyral, and polyvinyl alcohol. The intermediate layer is typically formed by coating the charge transport layer 1c with an intermediate layer coating liquid including a solvent, and a resin dissolved in the solvent using a known coating method, and then drying the coated liquid. The thickness of the intermediate layer is preferably from 0.05 μm to 2 μm.

In order that the photoreceptor can exhibit high stability to withstand environmental conditions, particularly, in order to prevent deterioration of the sensitivity, and increase of residual potential of the photoreceptor, each of the charge generation layer 1b, the charge transport layer 1c, and other layers such as the undercoat layer, the protective layer, and the intermediate layer can include additives such as antioxidants, plasticizers, lubricants, ultraviolet absorbents, and leveling agents.

Specific examples of the antioxidants are the following, but are not limited thereto.

### (a) Phenolic Compounds

2,6-Di-t-butyl-p-cresol, butylated hydroxyanisole, 2,6-di-t-butyl-4-ethylphenol, n-octadecyl-3-(4′-hydroxy-3′,5′-di-t-butylphenol), 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)-benzene, tetrakis-[methylene-3-(3′,5′-di-t-butyl-4-hydroxyphenyl)-propionate]methane, bis[3,3′-bis(4′-hydroxy-3′-t-butylphenyl)butyric acid]glycol ester, and tocophenol compounds.

### (b) Paraphenylenediamine Compounds

N-Phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, and N,N′-dimethyl-N,N′-di-t-butyl-p-phenylenediamine.

### (c) Hydroquinone Compounds

2,5-Di-t-octylhydroquinone, 2,6-didodecylhydroquinone, 2-dodecylhydroquinone, 2-dodecyl-5-chlorohydroquinone, 2-t-octyl-5-methylhydroquinone, and 2-(2-octadecenyl)-5-methylhydroquinone.

### (d) Sulfur-Containing Organic Compounds

Dilauryl-3,3′-thiodipropionate, distearyl-3,3′-thiodipropionate, and ditetradecyl-3,3′-thiodipropionate.

### (e) Phosphorus-Containing Organic Compounds

Triphenylphosphine, tri(nonylphenyl)phosphine, tri(dinonylphenyl)phosphine, tricresylphosphine, and tri(2,4-dibutylphenoxy)phosphine.

Specific examples of the plasticizers are the following, but are not limited thereto.

### (a) Phosphoric Acid Esters

Triphenyl phosphate, tricresyl phosphate, trioctyl phosphate, octyldiphenyl phosphate, trichloroethyl phosphate, cresyldiphenyl phosphate, tributyl phosphate, and tri-2-ethylhexyl phosphate.

### (b) Phthalic Acid Esters

Dimethyl phthalate, diethyl phthalate, diisobutyl phthalate, dibutyl phthalate, diheptyl phthalate, di-2-ethylhexyl phthalate, diisooctyl phthalate, di-n-octyl phthalate, dinonyl phthalate, diisononyl phthalate, diisodecyl phthalate, diundecyl phthalate, ditridecyl phthalate, dicyclohexyl phthalate, butylbenzyl phthalate, butyllauryl phthalate, methyloleyl phthalate, octyldecyl phthalate, dibutyl fumarate, and dioctyl fumarate.

### (c) Aromatic Carboxylic Acid Esters

Trioctyl trimellitate, tri-n-octyl trimellitate, and octyl oxybenzoate.

### (d) Dibasic Fatty Acid Esters

Dibutyl adipate, di-n-hexyl adipate, di-2-ethylhexyl adipate, di-n-octyl adipate, n-octyl-n-decyl adipate, diisodecyl adipate, dialkyl adipate, dicapryl adipate, di-2-etylhexyl azelate, dimethyl sebacate, diethyl sebacate, dibutyl sebacate, di-n-octyl sebacate, di-2-ethylhexyl sebacate, di-2-ethoxyethyl sebacate, dioctyl succinate, diisodecyl succinate, dioctyl tetrahydrophthalate, and di-n-octyl tetrahydrophthalate.

### (e) Fatty Acid Ester Derivatives

Butyl oleate, glycerin monooleate, methyl acetylricinolate, pentaerythritol esters, dipentaerythritol hexaesters, triacetin, and tributyrin.

### (f) Oxyacid Esters

Methyl acetylricinolate, butyl acetylricinolate, butylphthalylbutyl glycolate, and tributyl acetylcitrate.

### (g) Epoxy Compounds

Epoxydized soybean oil, epoxydized linseed oil, butyl epoxystearate, decyl epoxystearate, octyl epoxystearate, benzyl epoxystearate, dioctyl epoxyhexahydrophthalate, and didecyl epoxyhexahydrophthalate.

### (h) Dihydric Alcohol Esters

Diethylene glycol dibenzoate, and triethylene glycol di-2-ethylbutyrate.

### (i) Chlorine-Containing Compounds

Chlorinated paraffin, chlorinated diphenyl, methyl esters of chlorinated fatty acids, and methyl esters of methoxychlorinated fatty acids.

### (j) Polyester Compounds

Polypropylene adipate, polypropylene sebacate, and acetylated polyesters.

### (k) Sulfonic Acid Derivatives

p-Toluene sulfonamide, o-toluene sulfonamide, p-toluene sulfoneethylamide, o-toluene sulfoneethylamide, toluene sulfone-N-ethylamide, and p-toluene sulfone-N-cyclohexylamide.

### (l) Citric Acid Derivatives

Triethyl citrate, triethyl acetylcitrate, tributyl citrate, tributyl acetylcitrate, tri-2-ethylhexyl acetylcitrate, and n-octyldecyl acetylcitrate.

### (m) Other Compounds

Terphenyl, partially hydrated terphenyl, camphor, 2-nitro diphenyl, dinonyl naphthalene, and methyl abietate.

Specific examples of the lubricants include the following, but are not limited thereto.

### (a) Hydrocarbons

Liquid paraffins, paraffin waxes, micro waxes, and low molecular weight polyethylenes.

### (b) Fatty Acids

Lauric acid, myristic acid, palmitic acid, stearic acid, arachidic acid, and behenic acid.

### (c) Fatty Acid Amides

Stearamide, palmitamide, oleamide, methylenebisstearamide, and ethylenebisstearamide.

### (d) Ester Compounds

Lower alcohol esters of fatty acids, polyhydric alcohol esters of fatty acids, and polyglycol esters of fatty acids.

### (e) Alcohols

Cetyl alcohol, stearyl alcohol, ethylene glycol, polyethylene glycol, and polyglycerol.

### (f) Metallic Soaps

Lead stearate, cadmium stearate, barium stearate, calcium stearate, zinc stearate, and magnesium stearate.

### (g) Natural Waxes

Carnauba wax, candelilla wax, beeswax, spermaceti, insect wax, and montan wax.

### (h) Other Compounds

Silicone compounds, and fluorine compounds.

Specific examples of the ultraviolet absorbing agents include the following, but are not limited thereto.

### (a) Benzophenone Compounds

2-Hydroxybenzophenone, 2,4-dihydroxybenzophenone, 2,2′,4-trihydroxybenzophenone, 2,2′,4,4′-tetrahydroxybenzophenone, and 2,2′-dihydroxy-4-methoxybenzophenone.

### (b) Salicylate Compounds

Phenyl salicylate, and 2,4-di-t-butylphenyl-3,5-di-t-butyl-4-hydroxybenzoate.

### (c) Benzotriazole Compounds

(2′-Hydroxyphenyl)benzotriazole, (2′-hydroxy-5′-methylphenyl)benzotriazole, and (2′-hydroxy-3′-t-butyl-5′-methylphenyl)-5-chlorobenzotriazole.

### (d) Cyano Acrylate Compounds

Ethyl-2-cyano-3,3-diphenyl acrylate, and methyl-2-carbomethoxy-3-(paramethoxy)acrylate.

### (e) Quenchers (Metal Complexes)

Nickel(2,2′-thiobis(4-t-octyl)phenolate)-n-butylamine, nickeldibutyldithiocarbamate, and cobaltdicyclohexyldithiophosphate.

### (f) HALS (Hindered Amines)

Bis(2,2,6,6-tetramethyl-4-piperidyl)sebacate, bis(1,2,2,6,6-pentamethyl-4-piperidyl)sebacate, 1-[2-{3-(3,5-di-t-butyl-4-hydroxyphenyl)propionyloxy}ethyl]-4-{3-(3,5-di-t-butyl-4-hydroxyphenyl)propionyloxy}-2,2,6,6-tetrametylpyridine, 8-benzyl-7,7,9,9-tetramethyl-3-octyl-1,3,8-triazaspiro[4,5]undecane-2,4-dione, and 4-benzoyloxy-2,2,6,6-tetramethylpiperidine.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

Next, the experiments made by the present inventors will be described.

### [Experiment 1]

### (Preparation of Undercoat Layer)

The following components were mixed and the mixture was subjected to a dispersing treatment to prepare an undercoat layer coating liquid.

| | |
|---|---|
| Titanium dioxide powder | 400 parts |
| (TIPAQUE CR-EL from Ishihara Sangyo Kaisha K.K., | |
| which has average primary | |
| particle diameter of about 0.25 μm) | |
| Melamine resin | 65 parts |
| (SUPER BECKAMIN G821-60 from Dainippon Ink | |
| And Chemicals, Inc., solid content of 60%) | |
| Alkyd resin | 120 parts |
| (BECKOLITE M6401-50 from Dainippon Ink And | |
| Chemicals, Inc., solid content of 50%) | |
| 2-Butanone | 400 parts |

The undercoat layer coating liquid was applied on the circumferential surface of each of eight (8) aluminum drums each having a diameter of 30 mm and a length of 340 mm by a dip coating method, and the coated liquid was dried. Thus, an undercoat layer having a thickness of 3.5 μm was formed on each aluminum drum.

### (Preparation of Charge Generation Layer)

The following components were mixed and the mixture was subjected to a dispersing treatment to prepare a charge generation layer coating liquid.

| | |
|---|---|
| Fluorenone-type bisazo pigment having the following formula | 12 parts |
| 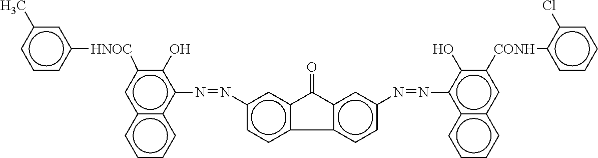 | |
| Polyvinyl butyral | 5 parts |
| (S-LEC BX-1 from Sekisui Chemical Co., Ltd.) | |
| 2-Butanone | 200 parts |
| Cyclohexanone | 400 Parts |

Initially, the polyvinyl butyral resin was dissolved in the solvent to prepare a polyvinyl butyral resin solution. Next, the pigment was added to the resin solution and the mixture was dispersed. Thus, a charge generation layer coating liquid was prepared.

The charge generation layer coating liquid was applied on each of the undercoat layers of the eight aluminum drums by a dip coating method, and the coated liquid was dried. Thus, a charge generation layer having a thickness of 0.1 μm was formed on each undercoat layer.

### (Preparation of Charge Transport Layer)

The following components were mixed to prepare a charge transport layer coating liquid.

| | |
|---|---|
| Charge transport material having the following formula | 9 parts |
| 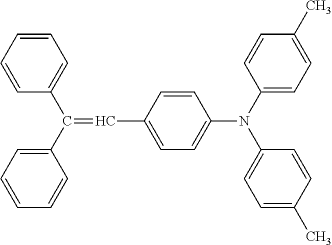 [SMILES: Cc1ccc(N(c2ccc(C)cc2)c2ccc(C=C(c3ccccc3)c3ccccc3)cc2)cc1] | |
| Polycarbonate | 10 parts |
| (TS-2050 from Teijin Chemicals Ltd.) | |
| Silicone oil | 0.002 parts |
| (KF50 from Shin-Etsu Chemical Co., Ltd.) | |
| Tetrahydrofuran | 100 parts |

The charge transport layer coating liquid was applied on each of the charge generation layers by a dip coating method, and the coated liquid was dried. Thus, a charge transport layer having a thickness of 28 μm was formed on each charge generation layer. Thus, the same eight photoreceptors were prepared.

Among the thus prepared eight photoreceptors, four photoreceptors were set to a digital color multifunction product (MFP), IMAGIO MP C2200 from Ricoh Co., Ltd., which has such a structure as illustrated in FIG. 1, so as to be used as image bearing members on which yellow, magenta, cyan and black toner images are to be formed. In each of the image forming units of the MFP, a probe of a surface potential meter was set in the vicinity of the developing device so as to face the photoreceptor to measure the surface potential of the photoreceptor just before the developing operation. In addition, the charge bias applied to the charger was controlled such that the surface of the photoreceptor was charged to have a potential of about −600V. Further, a development bias of −450V was applied to the development sleeve. Furthermore, the primary transfer power source was subjected to a constant current control so that a constant current was applied to each of the primary transfer bias rollers 9 of the transfer unit 15. The process linear velocity (i.e., the linear velocity of each photoreceptor 1 and the intermediate transfer belt 8) was 120 mm/s.

The photoreceptor 1K of the black image forming unit of the MFP in an initial state was subjected to a charging process in which the charge bias is applied to the photoreceptor, a developing process in which the development bias is applied to the development sleeve, and a primary transfer process in which the primary transfer bias is applied to the primary transfer bias roller, without subjected to an optical image writing process while driving the intermediate transfer belt, to measure the surface potential (P1) of the photoreceptor 1K with the probe. In this regard, the primary transfer current output from the primary transfer power source was set to an initial value Ta. This potential measuring operation was repeated except that the primary transfer current was set to a second value Tb greater than the initial value Ta to measure the surface potential (P2) of the photoreceptor 1K. As a result, there was no significant difference between the potentials P1 and P2.

Next, a 2×2 grey half tone image of A-4 size in portrait configuration, which includes a strip-shaped black solid image with a length of 20 mm (in the photoreceptor rotating direction) and a width of 100 mm (in the photoreceptor width direction) at the front edge of the image, was reproduced on each of 60,000 sheets of a recording material. After the running test, a copy of an A-4 size full color test pattern, in which letters are evenly arranged in the image area thereof so as to have an image area proportion of 5%, and a copy of the A-4 size 2×2 grey half tone image were continuously formed using the recording material sheets. As a result, the half tone image has an uneven image density due to a ghost image, which is a residual image of the letters of the full color test pattern. Thus, the photoreceptor 1K had been deteriorated to such an extent as to cause the uneven density image problem.

### Experiment 2

After the experiment 1 was completed, the surface potential measuring operations in Experiment 1 were repeated to measure the surface potential P1′ of the photoreceptor 1K when the primary transfer current was Ta, and the surface potential P2′ of the photoreceptor when the primary transfer current was Tb. As a result, it was discovered that the surface potential P2′ is much lower than the surface potential P2′ as illustrated in FIG. 4.

Thus, it is discovered that although the surface potentials P1 and P2 of the initial photoreceptor 1K were substantially the same, but the surface potentials P1′ and P2′ of the photoreceptor 1K, which had been deteriorated to such an extent as to cause the uneven density image problem, were largely different. This means that, in the deteriorated photoreceptor 1K, the surface potential of the photoreceptor largely changes after passing the primary transfer nip depending on the primary transfer current flowing through the photoreceptor at the primary transfer nip. The present inventors consider that degradation level of a photoreceptor can be estimated using this property.

### Experiment 3

The four photoreceptors, which were set to the MFP and which were used for the experiments 1 and 2, were replaced with the other four photoreceptors of the eight photoreceptors prepared above, which had not been used.

After the primary transfer current was set to 24 μA, a copy of the full color test pattern and a copy of the A-4 size 2×2 grey half tone image were continuously formed using the recording material sheets. Next, the produced half tone image was visually observed to determine whether a ghost image is present in the half tone image. In this regard, the quality of the half tone image (i.e., degradation level of the photoreceptor) was classified as follows.
⊚: No ghost image is observed in the half tone image (Excellent level).
◯: A ghost image is hardly observed in the half tone image (Good level).
Δ: A slight ghost image is observed in the half tone image (Acceptable level).
×: A ghost image is clearly observed in the half tone image (Bad level). In this case, the photoreceptor should be replaced with a new photoreceptor.

As a result of evaluation, no ghost image was not observed in the half tone image, and the photoreceptor in the initial state was on the excellent level (⊚) with respect to the degradation level.

Next, the photoreceptors and the intermediate transfer belt 8 were rotated at a process linear velocity of 120 mm/s and the photoreceptor 1K of the black image forming unit was subjected to the above-mentioned charging process, the above-mentioned developing process (development bias: −450V), and the above-mentioned primary transfer process (current of primary transfer bias: Ta) without subjected to an irradiating process to measure the surface potential (V1) of the photoreceptor 1K with the probe. This operation was repeated except that the linear velocity was changed to 60 mm/s to measure the surface potential (V2) of the photoreceptor 1K with the probe. As a result, the absolute value of the potential difference |V1−V2| was 6V.

Next, 30,000 copies of the gray half tone image were formed, and then a copy of the full color test pattern and a copy of the gray half tone image were continuously formed on the recording material sheets to determine whether a ghost image is observed. As a result of evaluation, a ghost image was hardly observed in the half tone image, and the photoreceptor 1K was on the good level (◯) with respect to the degradation level. In addition, the surface potentials V1 and V2 were measured. As a result, the absolute value of the potential difference |V1−V2| was 9V.

In addition, 30,000 copies of the gray half tone image were further formed, and then a copy of the full color test pattern and a copy of the gray half tone image were continuously formed on the recording material sheets to determine whether a ghost image is observed. As a result of evaluation, a ghost image was clearly observed in the half tone image, and the photoreceptor 1K was in the bad level (×) with respect to the degradation level. In addition, the surface potentials V1 and V2 were measured. As a result, the absolute value of the potential difference |V1−V2|was 14V.

Thus, it is found that the degree of degradation (such as formation of uneven density images due to ghost image) of a photoreceptor can be determined based on the potential difference |V1−V2|. In this regard, the degree of degradation can also be determined by a ratio (V1/V2) instead of the potential difference |V1−V2|. In addition, in the above-mentioned experiments, the linear velocity of the photoreceptor and the intermediate transfer belt is changed to change the total quantity of charges applied to the surface of the photoreceptor at the primary transfer nip by the primary transfer bias roller. However, the total quantity of charges applied to the surface of the photoreceptor may be changed by changing the primary transfer current instead of changing the linear velocity. Specifically, after the potential V1 is measured, the primary transfer current, which is output from the primary transfer power circuit, is changed without changing the linear velocity to measure the surface potential V2.

Further, in the experiments, the potential difference |V1−V2| (or potential ratio V1/V2), which is the dependence of a property of the photoreceptor on the charge quantity of the primary transfer bias (hereinafter referred to as charge quantity dependence), is determined by actually measuring the surface potentials. However, the charge quantity dependence of a photoreceptor can be determined by measuring a property of the photoreceptor other than the surface potential. For example, the following method can be used. Specifically, a photoreceptor is charged and then irradiated with light to form an electrostatic latent image, followed by developing the electrostatic latent image to form a half tone toner image and then primarily transferring the half tone toner image to an intermediate transfer belt. In this regard, the quantity of charge applied to the photoreceptor at the primary transfer nip is set to a predetermined quantity. Next, the amount (M1) of toner per a unit area of the half tone toner image is determined using an optical sensor or the like. In this regard, the amount of toner correlates with the surface potential of the photoreceptor. This toner amount measuring operation is repeated after changing the total quantity of charges applied to the surface of the photoreceptor at the primary transfer nip, to determine the amount (M2) of toner per a unit area of the half tone toner image. The charge quantity dependence of the photoreceptor can be determined based on the toner amount difference (M1−M2).

The charge quantity dependence (e.g., |V1−V2|, V2/V1, and M1−M2) of the photoreceptor can be used as the degradation level of the photoreceptor. Alternatively, a value obtained by subjecting the charge quantity dependence to an arithmetic processing may be used as the degradation level of the photoreceptor.

The results of Experiment 3 are shown in Table 1 below.

TABLE 1

| | Initial | After production of | After production of |
|---|---|---|---|
| | state | 30,000 copies | 60,000 copies |
| Degradation level of | ⊚ | ◯ | X |
| photoreceptor (Level | | | |
| of ghost image) | | | |
| \|V1-V2\| | 6 V | 9 V | 14 V |

### Experiment 4

The procedure for measurements of the surface potentials V1 and V2 in Experiment 3 was repeated except that the combination of measurements of the surface potentials V1 and V2 was repeated 10 times to obtain the average of ten data of the potential difference |V1−V2|. The results of Experiment 4 are shown in Table 2 below.

TABLE 2

| | Initial | After production of | After production of |
|---|---|---|---|
| | state | 30,000 copies | 60,000 copies |
| Degradation level of | ⊚ | ◯ | X |
| photoreceptor (Level | | | |
| of ghost image) | | | |
| \|V1-V2\| | 6.3 V | 9.2 V | 15.5 V |

It is clear from Tables 1 and 2 that the potential difference (15.5−14=1.5) after production of 60,000 copies between Experiments 3 and 4 is relatively large. This means that the potential difference measurement operation has a relative large margin of error. Therefore, it is preferable to perform the potential difference measurement operation plural times in order to estimate the degradation level of a photoreceptor.

### Experiment 5

The procedure for measurements of the surface potentials V1 and V2 in Experiment 3 was repeated except that measurement of the surface potential V2 was performed at the same linear velocity as that (120 mm/s) in measurement of the surface potential V1 to obtain the potential difference |V1−V2|. Specifically, the second surface potential V2 was measured under the same transfer current condition as that in measurement of the surface potential V1 (i.e., the second surface potential V2 was measured without changing the transfer current applied to the photoreceptor from the primary transfer power source via the primary transfer bias roller). The results of Experiment 5 are shown in Table 3 below.

TABLE 3

| | Initial | After production of | After production of |
|---|---|---|---|
| | state | 30,000 copies | 60,000 copies |
| Degradation level of | ⊚ | ◯ | X |
| photoreceptor (Level | | | |
| of ghost image) | | | |
| \|V1-V2\| | 2 V | 3 V | 3 V |

It is clear from Table 3 that the potential difference |V1−V2| hardly changes even when the degradation level of the photoreceptor greatly changes. Therefore, the degradation level of a photoreceptor cannot be determined from the potential difference |V1−V2|in this method. Namely, when the surface potentials V1 and V2 are measured under the same total charge quantity condition, the potential difference |V1−V2| is small, and therefore the degradation level of a photoreceptor cannot be estimated by this method.

Next, the characteristic structure of an example (multifunction product) of the image forming apparatus of the present invention will be described.

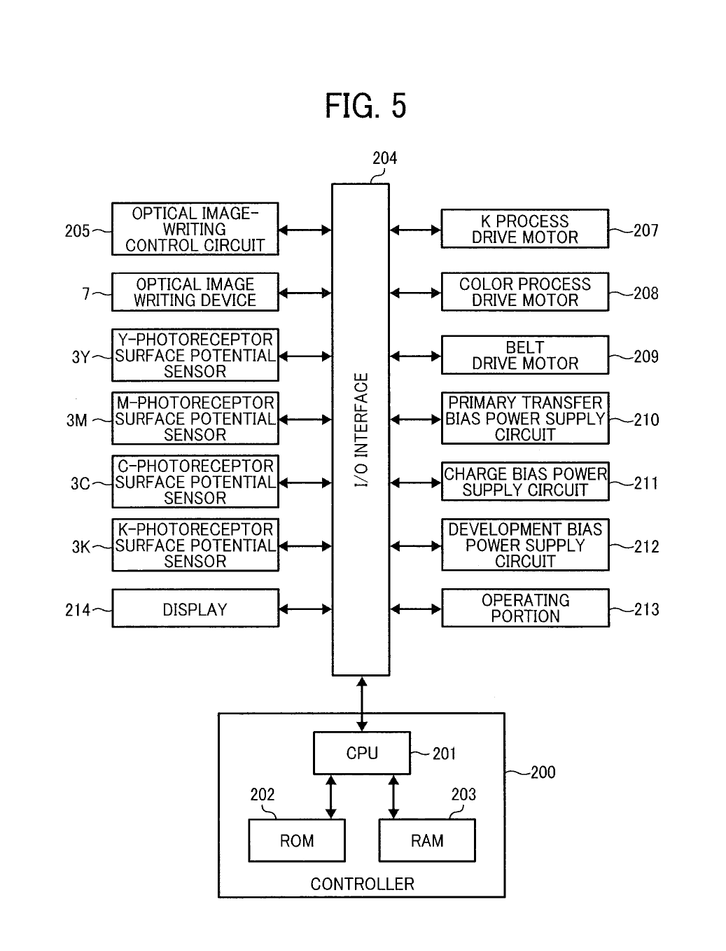

FIG. 5 is a block diagram illustrating part of the electric circuit of the multifunction product. In FIG. 5, a controller 200 serving as a part of the charge quantity dependence detector and a part of the display includes a CPU 201, a ROM 202 to store control program and various kinds of data, and a RAM 203 to temporarily store various kinds of data. The controller 200 is connected with the optical image writing device 7, an optical image-writing control circuit 205, the surface potential sensors 3Y, 3M, 3C and 3K, a K process drive motor 207, a color process drive motor 208, a belt driving motor 209, a primary transfer bias power supply circuit 210, a charge bias power supply circuit 211, a development bias power supply circuit 212, an operating portion 213, and a display 214 via an I/O interface 204. The optical image-writing control circuit 205 performs drive control on the optical image writing device 7. The surface potential sensors 3Y, 3M, 3C and 3K respectively detect the surface potentials of the photoreceptors 1Y, 1M, 1C and 1K. For example, as illustrated in FIG. 2, the surface potential sensor 3Y detects the surface potential of a portion of the photoreceptor 1Y at a location between the charger 4Y and the developing device 5Y after the portion passes the primary transfer nip, in which the photoreceptor is opposed to the primary transfer bias roller 9Y, and the charger 4Y.

The K process drive motor 207 is a drive source for driving various devices of the image forming unit 6K, and the color process drive motor 208 is a drive source for driving various devices of the image forming unit 6Y, 8M and 6C. In addition, the belt drive motor 209 is a drive source for driving the drive roller 12, which drives the intermediate transfer belt 8. The primary transfer bias power supply circuit 210 outputs a primary transfer current to the primary transfer bias rollers 9Y, 9M, 9C and 9K while performing constant current control. The charge bias power supply circuit 211 outputs a charge bias to the charging rollers 41 of the image forming units 6. The development bias power supply circuit 212 outputs a development bias to the sleeves of the developing rollers 51 of the image forming units 6. The operating portion 213 includes a numerical keyboard and different kinds of buttons, with which users can issue instructions to the multifunction product. The display 214 includes a liquid crystal display or the like, and displays images including literal information such as the degradation level of the photoreceptor and notification to user such that the life of the photoreceptor will expire shortly.

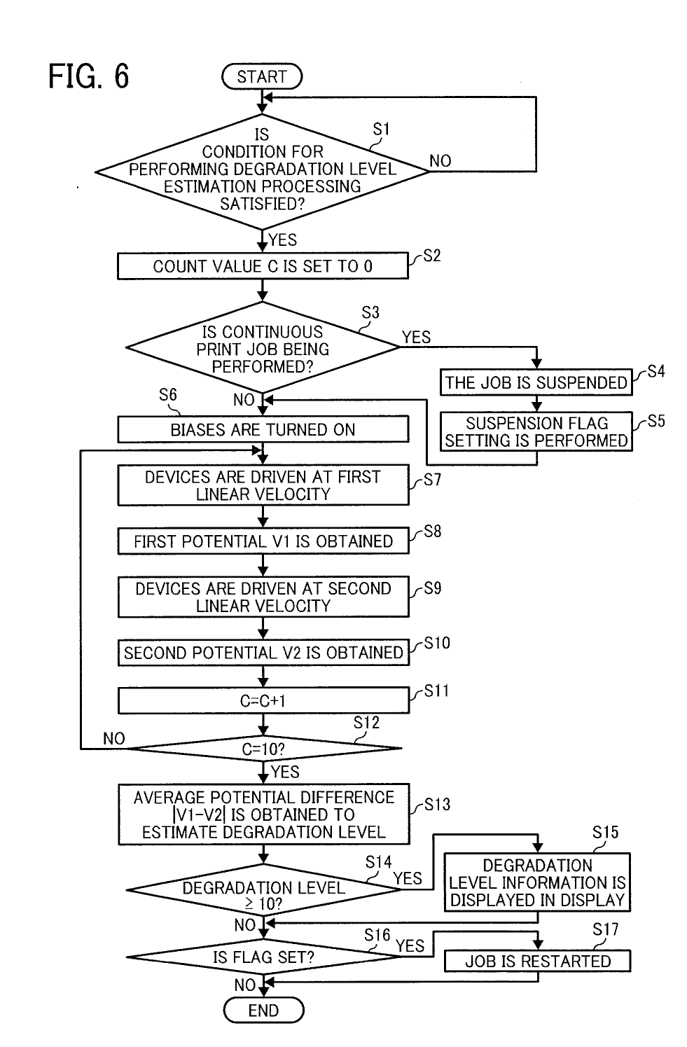

FIG. 6 is a flowchart illustrating process flow of a degradation level estimation processing performed by the controller 200. As illustrated in FIG. 6, initially the controller 200 judges at a predetermined frequency whether the conditions for performing the degradation level estimation processing are satisfied (step S1). For example, the controller 200 judges whether a predetermined number of copies have been produced from the last degradation level estimation processing. When the conditions are satisfied (Yes in step S1), the controller 200 sets the count value C to 0 (step S2), and then judges whether a continuous print job is being performed (step S3). When a continuous print job is being performed (Yes in step S3), the controller 200 suspends the continuous print job (step S4), and performs a suspension flag setting (step S5). In addition, the controller 200 controls such that the biases (charge bias, development bias, and primary transfer bias) are output (step S6). When the continuous print job is not performed (No in step S3), the biases are output immediately (step S6). Thereafter, the photoreceptors 1 and the intermediate transfer belt 8 are driven to rotate at a first linear velocity (e.g., 120 mm/s) (step S7), and the surface potential sensors 3 are operated to obtain data of surface potentials (i.e., first potentials V1) of the photoreceptors 1 (step S8). Next, the linear velocity of the photoreceptors 1 and the intermediate transfer belt 8 is changed to a second linear velocity (e.g., 60 mm/s) lower than the first linear velocity (step S9), and data of surface potentials (i.e., second potentials V2) of the photoreceptors 1 are obtained using the surface potential sensors 3 (step S10).

After combination potential data of the first and second surface potentials V1 and V2 are obtained, counting the count value C up by one (C=C+1) is performed (step S11), and it is judged whether or not the count C is 10 (step S12). When the count C is not 10 (No in step S12), the step S7 is executed again to obtain combination potential data. In contrast, when the count C is 10 (Yes in step S12), the potential difference |V1−V2| is obtained for each of the ten combination potential data for each photoreceptor to obtain the average potential difference of the photoreceptor, followed by storing the average potential difference as a degradation level of the photoreceptor (step S13). Next, it is judged whether the degradation level is not less than a predetermined threshold value 10 (step S14). When the degradation level is less than 10 (No in step S14), a flag is set (Yes in step S16), and the job is restarted (step S17) if necessary, resulting in completion of the processing. In contrast, when the degradation level is not less than 10 (Yes in step S14), information on the degradation level is displayed in the display (step S15), and the job is restarted (step S17) if necessary, resulting in completion of the processing. This degradation level estimation processing is performed on each photoreceptor 1Y, 1M, 1C or 1K in parallel.

When the degradation level is 10, the degradation level of the photoreceptor is a borderline level (i.e., a level (Δ) just before the bad level (×) in which the ghost image is clearly observed). Therefore, it is preferable to display the degradation level information on the display to notify users that the life of the photoreceptor will expire shortly, and a replacement photoreceptor should be obtained. It is also preferable that when the degradation level reaches a predetermined value (for example, 15), notification such that the life of the photoreceptor expires, the photoreceptor should be replaced is displayed.

It is not necessarily needed to continuously obtain the ten combination potential data, and it is possible to obtain the data at an interval (e.g., about 2 minutes). In addition, ghost images include a ghost image having a higher image density than the vicinity thereof, and a ghost image having a lower image density than the vicinity thereof. The degradation level estimation device of the present invention can be used for each case.

Hereinbefore, the present invention has been described by reference to a multifunction product in which toner images formed on photoreceptors are transferred onto a recording material via an intermediate transfer belt. However, the present invention is not limited thereto, and can be applied to an image forming apparatus, in which one or more toner images formed on one or more photoreceptors are directly transferred onto a recording material fed by a feeding belt, or the like image forming apparatus.

In the above-mentioned multifunction product, the controller 200 and the surface potential sensors 3 constitute the charge quantity dependence detector. By measuring the potential difference |V1−V2↑ for each of the photoreceptors 1, the degradation level of each of the photoreceptors 1 (i.e., whether the photoreceptor forms uneven density images caused by a ghost image) can be estimated.

The above-mentioned multifunction product is an example of the present invention, and the present invention includes the following embodiments.

### Embodiment A

This embodiment concerns a degradation level estimating device for use in an image forming apparatus, which includes an endless photoreceptor (e.g., photoreceptor 1) rotating while bearing an electrostatic latent image thereon, a charger (e.g., charger 4) to charge a surface of the photoreceptor (i.e., to perform a charging process), an optical image writing device (e.g., optical image writing device 7) to irradiate the charged photoreceptor with light (i.e., to perform an optical image writing process) to form the electrostatic latent image on the surface of the photoreceptor, a developing device (e.g., developing device 5) to develop the electrostatic latent image with a toner (i.e., to perform a developing process) to form a toner image on the surface of the photoreceptor, and a transferring device (e.g., primary transfer bias roller 9) to transfer the toner image onto a receiver (i.e., transferring process) while applying a charge to the surface of the photoreceptor. The degradation level estimating device includes a charge quantity dependence detector to detect dependence of a charge property of the photoreceptor in the charging process on the quantity of charge applied to the photoreceptor in the last transferring process. Specifically, after the photoreceptor starts to rotate, the photoreceptor is subjected to the charging process at least twice without performing the optical image writing process. The charge dependence detector detects the dependence of a charge property of the photoreceptor in the charging process after subjecting the photoreceptor to the charging process at least twice on the quantity of charge applied to the photoreceptor in the transferring process by changing the quantity of charge applied to the photoreceptor in the transferring process. The degradation level estimating device estimates the degradation level of the photoreceptor (i.e., the degree of unevenness of images produced by the photoreceptor due to ghost images) based on the charge quantity dependence or a value obtained by subjecting the charge quantity dependence to an arithmetic processing.

### Embodiment B

This embodiment B is characterized in that the charge quantity dependence detector is a surface potential detector (e.g., surface potential sensor 3) and the charge property of the photoreceptor in the embodiment A is a surface potential of the photoreceptor detected by the surface potential detector. By using this degradation level estimating device, the degradation level of the photoreceptor can be easily estimated without producing a half tone image to measure the weight of toner per a unit area.

### Embodiment C

This embodiment C is characterized in that the surface potential detector mentioned above in the embodiment B measures a first potential (V1) of the photoreceptor measured when the quantity of charge applied to the photoreceptor in the transferring process is a first predetermined charge quantity, and a second potential (V2) of the photoreceptor when the quantity of charge applied to the photoreceptor in the transferring process is a second predetermined charge quantity, to obtain the potential difference |V1−V2| or the potential ratio V2/V1. The degradation level estimating device estimates the degradation level (i.e., the degree of unevenness of images produced by the photoreceptor due to ghost images) of the photoreceptor based on the potential difference or the potential ratio. Therefore, the degradation level estimating device can precisely estimate the degradation level.

### Embodiment D

This embodiment D is characterized in that the charge quantity dependence detector mentioned above in the embodiment A detects the dependence of a charge property of the photoreceptor in the charging process on the quantity of charge applied to the photoreceptor in the transfer process by changing the linear velocity of the surface of the photoreceptor in the transferring process without changing the quantity of transfer current output from the transferring device. Since it is not necessary in this embodiment to provide an additional circuit in the power source to output the transfer current, increase of costs of the degradation level estimating device can be avoided.

### Embodiment E

This embodiment E is characterized in that the degradation level estimating device further includes a display. When the degradation level of the photoreceptor estimated based on the dependence of a charge property of the photoreceptor in the charging process on the charge quantity is greater than or not less than a threshold level, the display displays information on the dependence of a charge property of the photoreceptor or the degradation level of the photoreceptor. By using this degradation level estimating device, users are notified that the life of the photoreceptor will expire shortly.

### Embodiment F

This embodiment F is characterized in that in the embodiment E mentioned above the dependence of a charge property of the photoreceptor is repeatedly measured plural times in a predetermined period of time to obtain the average dependence. When the average charge quantity dependence or a degradation level obtained by subjecting the average charge quantity dependence data to an arithmetic processing is greater or not less than a predetermined threshold value, the display displays information on the average charge quantity dependence or the degradation level of the photoreceptor. By using this degradation level estimating device, the degradation level of the photoreceptor can be estimated more precisely.

Additional modifications and variations of the present invention are possible in light of the above teachings. It is therefore to be understood that within the scope of the appended claims the invention may be practiced other than as specifically described herein.

What is claimed is:

1. A degradation level estimating device for estimating a degradation level of an endless photoreceptor of an image forming apparatus, which performs an image forming process including at least a charging process, an optical image forming process, a developing process, and a transferring process and which includes:
the endless photoreceptor to bear an electrostatic latent image on a surface thereof while rotating;
a charger to subject the photoreceptor to the charging process in which a charge bias is applied to the surface of the photoreceptor to charge the surface of the photoreceptor;
an optical image writing device to subject the photoreceptor to the optical image writing process in which the charged surface of the photoreceptor is irradiated with light to form the electrostatic latent image on the surface of the photoreceptor;
a developing device to subject the photoreceptor bearing the electrostatic latent image thereon to the developing process in which the electrostatic latent image is developed with a toner while applying a development bias to the photoreceptor to form a toner image on the surface of the photoreceptor; and
a transferring device to subject the photoreceptor bearing the toner image thereon to the transferring process in which the toner image on the surface of the photoreceptor is transferred onto a receiver while applying a charge to the surface of the photoreceptor,
the degradation level estimating device comprising:
a charge quantity dependence detector to detect charge quantity dependence of a charge property of the photoreceptor charged in the charging process on a quantity of the charge applied to the photoreceptor in the last transferring process by a method including rotating the photoreceptor, and then subjecting the photoreceptor to the image forming process at least twice without performing the optical image writing process, followed by the charging process, while changing the quantity of the charge applied to the photoreceptor in the transferring process and measuring the charge property of the charged photoreceptor to detect the charge quantity dependence of the charge property of the photoreceptor charged in the charging process on the quantity of the charge applied to the photoreceptor in the last transferring process,
wherein the degradation level estimating device estimates the degradation level of the photoreceptor based on the charge quantity dependence or arithmetic data obtained by subjecting the charge quantity dependence to an arithmetic processing.

2. The degradation level estimating device according to claim 1, wherein the charge quantity dependence detector includes a surface potential detector to measure a surface potential of the charged photoreceptor as the charge property, wherein the surface potential detector obtains plural data of the surface potential of the photoreceptor charged in the charging process by changing the quantity of the charge applied to the photoreceptor in the last transferring process, and wherein the charge quantity dependence detector detects the charge quantity dependence of the charge property of the photoreceptor based on the plural data of the surface potential.

3. The degradation level estimating device according to claim 2, wherein the surface potential detector detects a first surface potential (V1) of the photoreceptor when the quantity of the charge applied to the photoreceptor in the last transferring process is set to a first predetermined charge quantity, and a second surface potential (V2) of the photoreceptor when the quantity of the charge applied to the photoreceptor in the last transferring process is set to a second predetermined charge quantity different from the first predetermined charge quantity, to obtain a potential difference |V1−V2| or a potential ratio V2/V1, and wherein the charge quantity dependence detector detects the charge quantity dependence of the charge property of the photoreceptor based on the potential difference or the potential ratio.

4. The degradation level estimating device according to claim 1, wherein the charge dependence detector detects the charge quantity dependence of the charge property of the photoreceptor by changing a linear velocity of the surface of the photoreceptor without changing an amount of a transfer current, which is output from the transferring device to apply the charge to the photoreceptor.

5. The degradation level estimating device according to claim 1, further comprising:
a display,
wherein when the charge quantity dependence of the charge property of the photoreceptor or the degradation level of the photoreceptor estimated by the degradation level estimating device is greater than or not less than a threshold level, the display displays information on the charge quantity dependence or the degradation level of the photoreceptor.

6. The degradation level estimating device according to claim 5, wherein the charge dependence detector repeatedly detects the charge quantity dependence plural times in a predetermined period of time to obtain an average of the charge quantity dependence, and wherein when the average of the charge quantity dependence or an average of the degradation level, which is obtained from the average of the charge quantity dependence, is greater or not less than the predetermined threshold value, the display displays information on the average of the charge quantity dependence or the average of the degradation level of the photoreceptor.

7. An image forming apparatus comprising:
an endless photoreceptor to bear an electrostatic latent image thereon while rotating;
a charger to subject the photoreceptor to a charging process in which a charge bias is applied to a surface of the photoreceptor to charge the surface of the photoreceptor;
an optical image writing device to subject the charged photoreceptor to an optical image writing process in which the surface of the charged photoreceptor is irradiated with light to form the electrostatic latent image on the surface of the charged photoreceptor;
a developing device to subject the photoreceptor bearing the electrostatic latent image thereon to a developing process in which the electrostatic latent image is developed with a toner while applying a development bias to the photoreceptor to form a toner image on the surface of the photoreceptor;
a transferring device to subject to the photoreceptor to a transferring process in which the toner image on the surface of the photoreceptor is transferred onto a receiver while applying a charge to the surface of the photoreceptor; and
the degradation level estimating device according to claim 1 to estimate degradation level of the endless photoreceptor.

8. The image forming apparatus according to claim 7, wherein the charge quantity dependence detector includes a surface potential detector to measure a surface potential of the charged photoreceptor as the charge property, wherein the surface potential detector obtains plural data of the surface potential of the photoreceptor charged in the charging process by changing the quantity of the charge applied to the photoreceptor in the last transferring process, and wherein the charge quantity dependence detector detects the charge quantity dependence of the charge property of the photoreceptor based on the plural data of the surface potential.

9. The image forming apparatus according to claim 8, wherein the surface potential detector detects a first surface potential (V1) of the photoreceptor when the quantity of the charge applied to the photoreceptor in the last transferring process is set to a first predetermined charge quantity, and a second surface potential (V2) of the photoreceptor when the quantity of the charge applied to the photoreceptor in the last transferring process is set to a second predetermined charge quantity different from the first predetermined charge quantity, to obtain a potential difference |V1−V2| or a potential ratio V2/V1, and wherein the charge quantity dependence detector detects the charge quantity dependence of the charge property of the photoreceptor based on the potential difference or the potential ratio.

10. The image forming apparatus according to claim 7, wherein the charge dependence detector detects the charge quantity dependence of the charge property of the photoreceptor by changing a linear velocity of the surface of the photoreceptor without changing an amount of a transfer current, which is output from the transferring device to apply the charge to the photoreceptor.

11. The image forming apparatus according to claim 7, further comprising:
a display,
wherein when the charge quantity dependence of the charge property of the photoreceptor or the degradation level of the photoreceptor estimated by the degradation level estimating device is greater than or not less than a threshold level, the display displays information on the charge quantity dependence or the degradation level of the photoreceptor.

12. The image forming apparatus according to claim 11, wherein the charge dependence detector repeatedly detects the charge quantity dependence plural times in a predetermined period of time to obtain an average of the charge quantity dependence, and wherein when the average of the charge quantity dependence or an average of the degradation level, which is obtained from the average of the charge quantity dependence, is greater or not less than the predetermined threshold value, the display displays information on the average of the charge quantity dependence or the average of the degradation level of the photoreceptor.
